(19) United States
(12) Patent Application Publication
(10) Pub. No.: US 2014/0344708 A1
(43) Pub. Date: Nov. 20, 2014

(54) System and Methods for Capturing and Managing Business Intelligence Requirements

(71) Applicants: Michael Carr, Chantilly, VA (US); Andrew Patterson, Burke, VA (US); Jacqueline Meriwether, Fairfax, VA (US); Robert McWaters, Harvard, MA (US)

(72) Inventors: Michael Carr, Chantilly, VA (US); Andrew Patterson, Burke, VA (US); Jacqueline Meriwether, Fairfax, VA (US); Robert McWaters, Harvard, MA (US)

(21) Appl. No.: 14/210,550

(22) Filed: Mar. 14, 2014

Related U.S. Application Data
(60) Provisional application No. 61/782,760, filed on Mar. 14, 2013.

(51) Int. Cl. G06F 3/0481; G06F 3/0484

(52) U.S. Cl. CPC G06F 3/0481; G06F 3/0484
USPC 715/751

(57) ABSTRACT

A method of capturing business intelligence requirements includes establishing a graphical object definition interface, receiving user input through this interface to define various requirements objects, and storing the user-defined requirements objects in an object library. A graphical business intelligence outputs interface can also be established, such that users can provide input to define business intelligence outputs, each of which includes at least one requirements object from the object library expressed in reports and/or dashboards. Systems for practicing this and related methods are also disclosed.

### CROSS-REFERENCE TO RELATED APPLICATIONS

This application claims the benefit of U.S. provisional application No. 61/782,760, filed 14 Mar. 2013, which is hereby incorporated by reference as though fully set forth herein.

### BACKGROUND

This disclosure relates to capturing and managing requirements for business intelligence reporting systems. It also relates to accelerated project and report development by automating the creation of objects in the reporting system.

Business intelligence requirements, particularly report and dashboard requirements, are notoriously difficult to capture and often necessitate a back-and-forth process between the end-user and the developer to resolve differences in the business's vision, the business's request, and the developer's actual implementation. Moreover, once requirements are captured, it is important to the success of a business intelligence project to manage changes and deliver a final product based on the agreed-upon requirements.

### BRIEF SUMMARY

Disclosed herein are methods and systems that provide, through a web-based user interface, a tool that allows users to describe their organization in their own terminology and design reports and dashboards meeting their needs. Business intelligence requirements can be defined through an interactive and intuitive drag-and-drop interface. Users can automatically generate requirements documentation in multiple formats, and can receive suggestions of additional requirements based on requirements objects that are often paired together in order to facilitate the creation of a comprehensive set of requirements. This can assist users in managing requirements by documenting all requirement changes, comparing changes to project baselines, assigning tasks to other users, and automating the creation of reporting objects based on requirements.

Disclosed herein is a method of capturing business intelligence requirements, including: (a) establishing a graphical object definition interface; (b) receiving, through the graphical object definition interface, user input to define a requirements object; (c) storing the requirements object defined by the user input in an object library; (d) repeating steps (a), (b), and (c) to store a plurality of requirements objects in the object library; (e) establishing a graphical business intelligence outputs interface; and (f) receiving, through the graphical business intelligence outputs interface, user input to define a business intelligence output, wherein the business intelligence output includes at least one requirements object from the object library expressed as at least one of a report and a dashboard.

Also disclosed herein is a system for capturing business intelligence requirements, including: an object definition interface processor that generates a graphical object definition interface and that receives, via the graphical object definition interface, user input to define a plurality of requirements objects; and a business intelligence outputs interface processor that generates a graphical business intelligence outputs interface and that receives, via the graphical business intelligence outputs interface, user input to define a business intelligence output, wherein the business intelligence output comprises at least one requirements object from the plurality of requirements objects expressed as at least one of a report and a dashboard.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 depicts a representative computing environment within which the teachings herein can be practiced to good advantage.

FIG. 2 is a representative user interface architecture in accordance with an embodiment of the teachings herein.

FIG. 3 illustrates a user interface for establishing a requirements gathering session within a project according to an exemplary embodiment of the teachings herein.

FIG. 4 illustrates a user interface for creating and editing objects according to an exemplary embodiment of the teachings herein.

FIG. 5 illustrates a user interface for capturing a concept definition according to an exemplary embodiment of the teachings herein.

FIG. 6 illustrates a user interface for capturing a measure definition according to an exemplary embodiment of the teachings herein.

FIG. 7 illustrates a user interface for capturing a filter definition according to an exemplary embodiment of the teachings herein.

FIG. 8 illustrates a user interface for capturing a report definition according to an exemplary embodiment of the teachings herein.

FIG. 9 illustrates a user interface for capturing a dashboard definition according to an exemplary embodiment of the teachings herein.

FIG. 10 illustrates a dashboard definition with layout previews and component toolbar according to an exemplary embodiment of the teachings herein.

FIG. 11 illustrates a user interface for re-ordering requirements according to an exemplary embodiment of the teachings herein.

FIG. 12 illustrates a user interface for exporting requirements as highly formatted documentation according to an exemplary embodiment of the teachings herein.

FIG. 13 is a flowchart of representative steps that can be carried out when performing a project management workflow in accordance with an exemplary embodiment of the teachings herein.

FIG. 14 is a flowchart of representative steps that can be carried out to suggest additional requirements objects in accordance with an exemplary embodiment of the teachings herein.

FIG. 15 is a flowchart of representative steps that can be carried out to retrieve requirement object statistics in accordance with an exemplary embodiment of the teachings herein.

### DETAILED DESCRIPTION

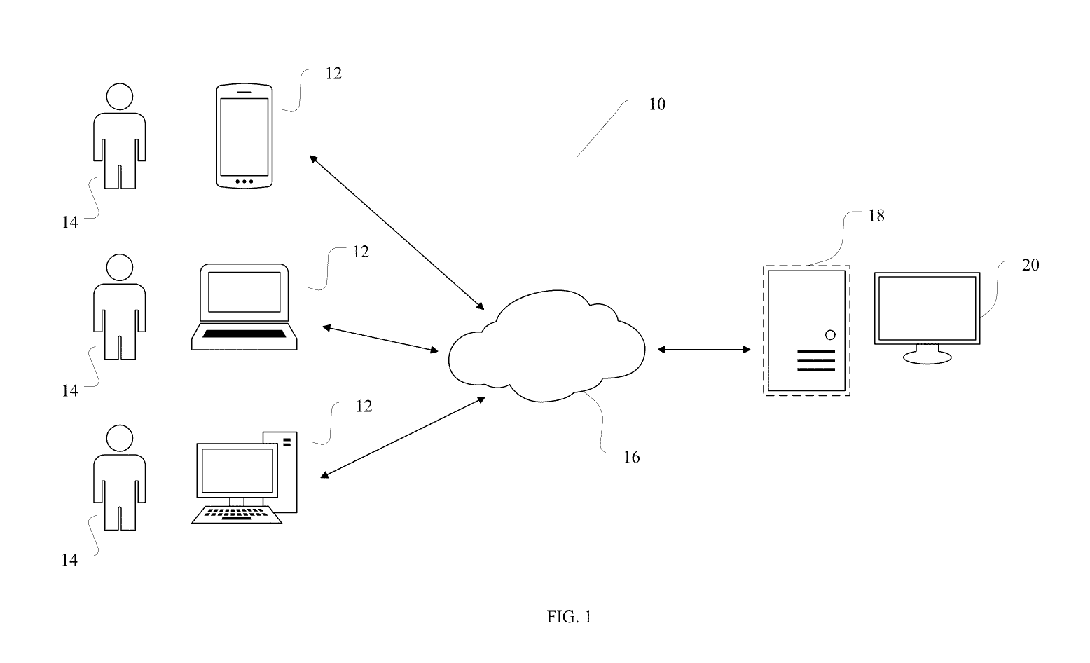

FIG. 1 depicts a representative computing environment 10 in which the teachings herein can be practiced. Environment 10 generally includes a plurality of client or user computing devices 12, each belonging to and/or used by a corresponding client or user 14. Although only three computing devices 12 and corresponding users 14 are shown in FIG. 1, this is only for the sake of illustration, and environment 10 can include any number of computing devices 12 and corresponding users 14 without departing from the instant teachings.

Client computing devices 12 can be any computing device including, without limitation, general purpose computers, special purpose computers, distributed computers, desktop computers, laptop computers, tablet computers, smartphones, and the like. In general, client computing devices 12 include a processor, memory (e.g., random access memory, or “RAM”), storage (e.g., a mechanical hard drive or solid state drive), and a display. As used herein, the term “processor” refers not only to a single central processing unit (“CPU”), but also to a plurality of CPUs, commonly referred to as a parallel processing environment. Client computing devices 12 can also include additional devices, such as various input devices (e.g., keyboards, trackpads, touchscreens) and output devices (e.g., speakers, printers).

Client computing devices 12 are coupled to a network 16, such as a local area network (“LAN”) or the Internet. Thus, client computing devices 12 and/or users 14 can communicate with each other over network 16. The ordinarily skilled artisan will be familiar with numerous ways to connect client computing devices 12 to network 16, including via wire (e.g., Ethernet) or via a wireless connection (e.g., 802.11, Bluetooth). Amongst other capabilities, client computing devices 12 can include a browser, such as Microsoft's Internet Explorer browser, Apple's Safari browser, Mozilla's Firefox browser, Google's Chrome browser, or the like, that can be used to access network 16 (for purposes of explanation and illustration, the Internet).

A server device 18 is also coupled to network 16, thus allowing client computing devices 12 to communicate with server device 18. Similar to client computing devices 12, server device 18 can include a processor, memory, storage, and a display 20, as well as additional devices. Moreover, although server device 18 is depicted as a single physical machine, it is contemplated that server device can be a distributed computing environment including multiple physical and/or virtual devices including multiple CPUs, multiple cores, and/or multiple threads.

A user interface can be established, for example, by server device 18 executing (e.g., by one or more processors) computer-readable program instructions that are stored in its memory and/or storage. The interface can be established on the display of a client computing device 12, such as in response to a request from client computing device 12 that takes the form of user 14 using the browser of client computing device 12 to visit a particular uniform resource locator (“URL”) for server device 18, and, more particularly, for the functions of server device 18 as described herein.

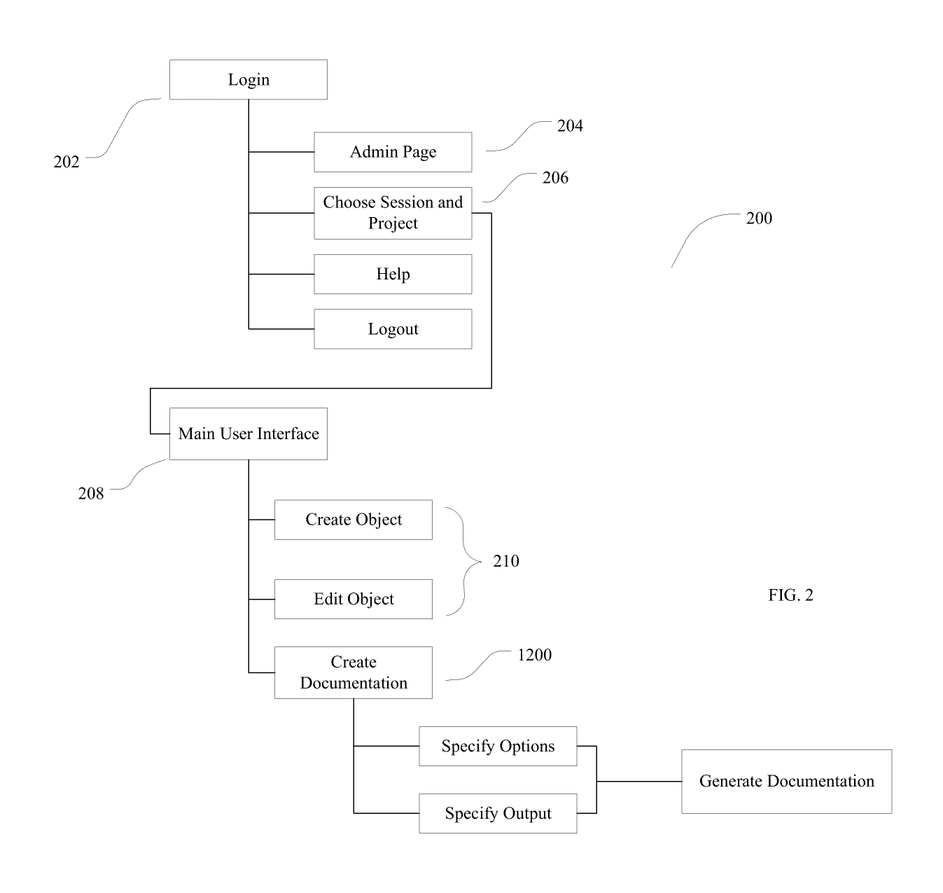

FIG. 2 depicts a representative user interface architecture 200 according to an embodiment of the teachings herein. As shown in FIG. 2, the user interface begins at a login screen 202. Insofar as developing and maintaining a business intelligence application is a team effort involving distinct and complementary skill sets and roles, it is contemplated that each user 14 can have and log in to a unique account on server device 18. This facilitates simultaneous access by multiple users to create or modify objects as described herein. This provides advantages over traditional methods and systems for creating requirements documents, where only one user can typically access and update the requirements document at any given time (i.e., concurrent users are not contemplated by extant methods and systems for creating business intelligence requirements documents). These unique accounts can be created, managed, edited, and the like by a user with sufficient privileges through an administrative user interface 204.

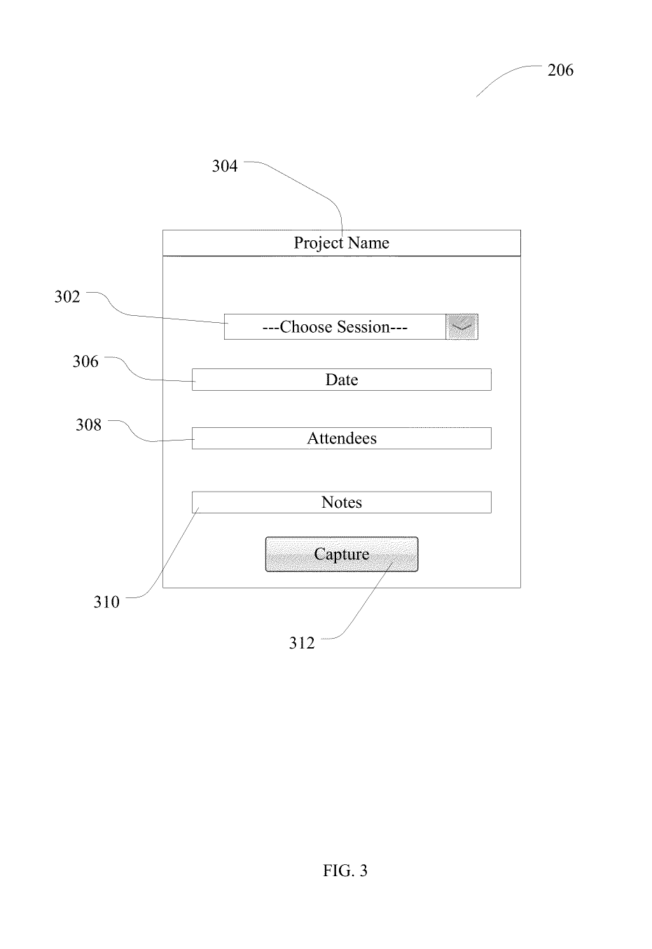

One aspect of the requirements gathering process is the ability to link requirements to the user 14 or group of users 14 making the request. This linking facilitates prioritization of requirements and the understanding of overlapping requests. Thus, as an initial gateway, server device 18 may establish an interface 206, one suitable embodiment of which is depicted in FIG. 3, that permits a user 14 to choose a session (e.g., using dropdown box 302) and project (shown, for example, in project title bar 304). As further depicted in FIG. 3, user 14 can also input the date (e.g., date field 306), attendees (e.g., attendee field 308), and notes for the session (e.g., notes field 310). Upon clicking the capture button 312, the user interface will pass to the main user interface 208, and subsequent edits or creations will be associated with the specified requirements gathering session.

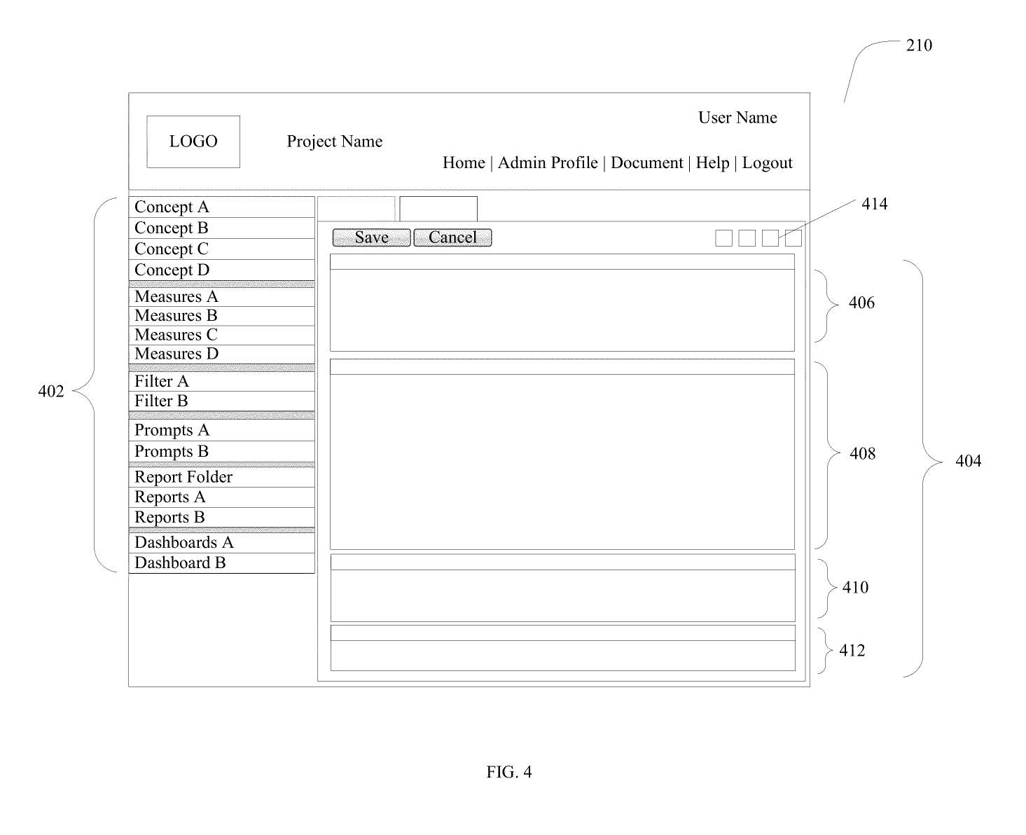

Requirements can be saved in system metadata referred to herein as the object library, one representative form of which is depicted in FIG. 4. In particular, FIG. 4 depicts a user interface 210 for the creation and editing of objects, including the object library 402 and the object editor interface 404.

As shown, object library 402 groups and displays five object types that will be discussed in further detail herein: concepts, measures, filters, reports, and dashboards. It should be understood that these five objects types are merely exemplary and presented for purposes of illustration only. It is expressly contemplated that embodiments of the systems and methods disclosed herein can have more, fewer, the same, similar, and/or different object types. The person of ordinary skill in the art will appreciate, from the instant disclosure, how to extend the teachings herein to additional and different object types.

Depending on permissions, a user 14 can view, edit, and/or create objects in object editor interface 404, which can include, without limitations, the following panes: an object general information pane 406, an object definition pane 408, an object change history pane 410, and an object workflow pane 412. These panes can be shown or hidden by selecting the appropriate check boxes 414.

When an object is created or edited, it can be displayed in object editor interface 404, and it is contemplated that multiple objects can be edited simultaneously. In general, each object, regardless of type, will possess certain basic information such as name, folder (for organizing and classifying objects), description, and any file attachments users wish to upload. This basic information can be input, displayed, and/or edited in object general information pane 406.

Each object can also contain a definition, which will typically be unique to the object type. The definition can be input, displayed, and/or edited in object definition pane 408.

A history of modifications made to the object can be displayed in object change history pane 410. Similarly, a workflow for capturing and assigning project tasks can be displayed in object workflow pane 412.

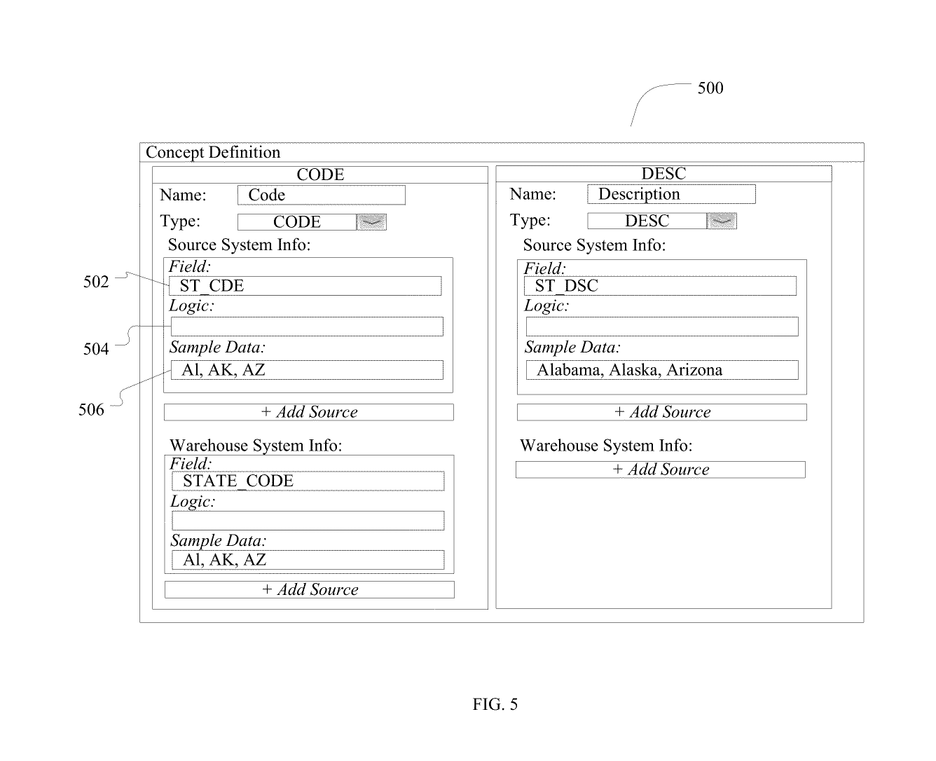

The definition for each object type will now be discussed in greater detail with reference to the representative user interfaces depicted in FIGS. 5-10, each of which can be displayed within object definition pane 408, as a full-screen image, or in any other desirable fashion. To facilitate streamlined object definition, the user interface can provide user 14 with autocomplete lists and drop zones. Autocomplete lists present user 14 with a list of objects from the object library as user 14 inputs a search query, much like many Internet search engines will attempt to autocomplete search queries. This enables user 14 to quickly access objects without the need to go to object library 402.

When an object is selected from the autocomplete list, it is automatically added to the corresponding drop zone. If a user with permissions to create objects enters a query for an object that does not exist, a new object can be added to the object library. Alternatively or additionally, user 14 can drag and drop objects from object library 402 to the desired drop zone.

Concept definitions, for example as shown in FIG. 5, are designed to capture the data lineage for all source and target data sources for the business concepts that define how an organization looks at itself (e.g., geographical traits, date attributes, product characteristics, and the like). Many organizations capture data in online transaction processing (OLTP) systems designed to quickly input data, but these systems are often highly inefficient for reading/reporting data. Thus, data from OLTP systems is often moved to an online analytical processing data source for reporting. The data is typically cleaned and validated as it is moved through an extract, transform, and load (ETL) process.

As shown in FIG. 5, the user interface 500 established by server device 18 for purposes of capturing concept definition can permit users to capture information about both source (OLTP) and target (OLAP) data sources. For each data source, users may input any or all of the following information: the database field where the data resides (e.g., column, procedure, or the like) 502; the logic used by the ETL process to clean or filter the data 504; and/or sample data 506.

Business concepts in a reporting system can often be expressed in multiple ways. For example, if an organization reports on states, users may wish to view two-letter state codes (e.g., AL, AK, AZ), or they may wish to view full state names (e.g., Alabama, Alaska, Arizona). Thus, as shown in FIG. 5, multiple expressions can be captured/defined for a single business concept, each of which can contain multiple source and target mappings.

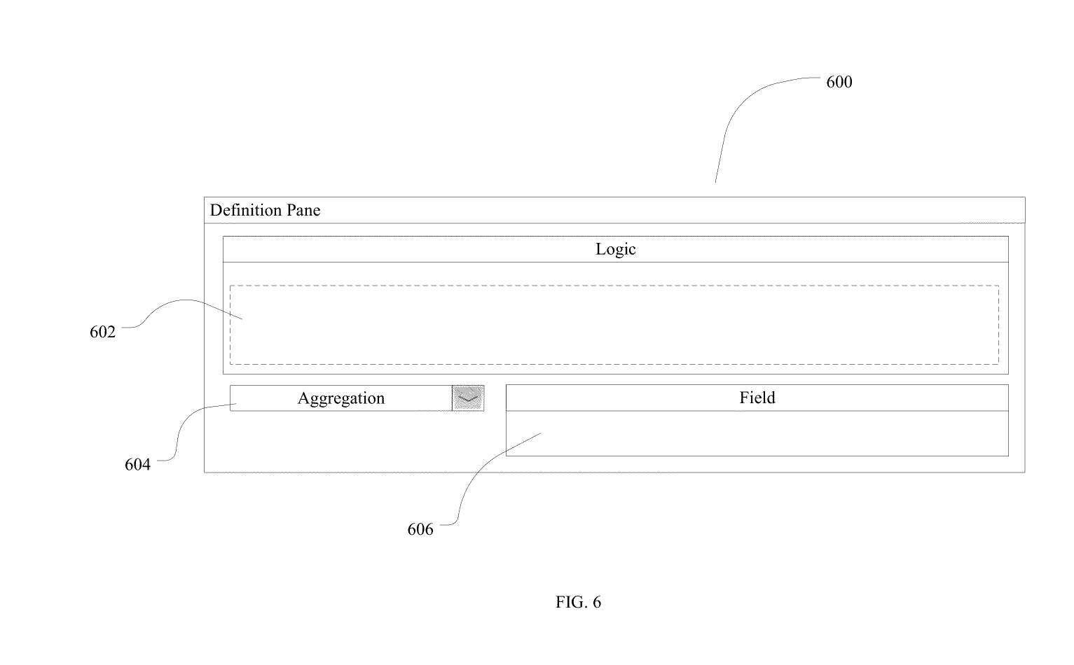

Measure definitions, for example as shown in FIG. 6, are designed to capture the ways by which an organization measures its success. Using metrics such as revenue, profit, number of customers, and the like, an organization can set goals and measure their attainment. FIG. 6 depicts a user interface 600 for the definition of a measure object, including fields to capture the following aspects of a measure object: a source system field 606; an aggregation (e.g., sum, average, or the like) field 604; and a field 602 for the input of additional logic, such as filtering logic, time-series transformation logic (e.g., this year versus last year), and the like.

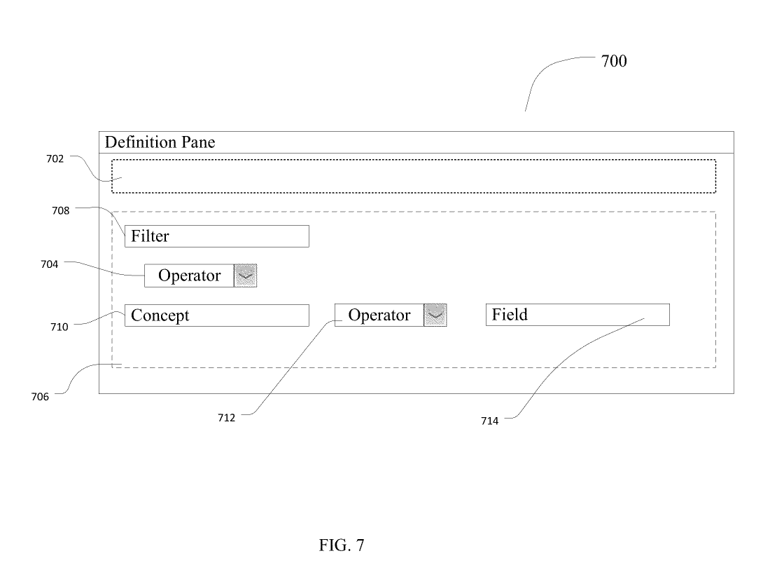

Filter definitions, for example as shown in FIG. 7, are designed to capture specific conditional logic that can be applied to other objects, such as reports, measures, and the like. For example, a filter with the logic “Region=New England” can be used on a measure that calculates the specific revenue created in New England, or it can be used in a report that shows multiple measures, all of which are calculated based on the New England region. FIG. 7 depicts a user interface 700 for the definition of a filter object, including fields to capture the following aspects of a filter object: an autocomplete box 702 to query objects from the object library 402 and a dropzone box 706 where objects added to the filter will be displayed.

Concepts, measures, and other filters can all be added to dropzone box 706. Multiple filter conditions, including existing filter definitions 708, can be included in a single filter definition. When this occurs, user 14 can set the relationship operator 704, such as AND, OR, NOT AND, etc., to control the interaction between filter conditions. For example, a filter can be created for “Region=New England AND Date=Today.”

User interface 700 can also include a field 710 for user 14 to input an object from the object library, a dropdown 712 to select an operator (e.g., =, <, >), and a field 714 to specify a value or list of values. For example, in the input “Region=New England,” “New England” is the value provided by user 14 to document the filter requirement.

User interface 700 can further include a field for user 14 to input another object. For example, in the input “Cost>Revenue,” the measure object “Cost” is being compared to the measure object “Revenue.”

It is also contemplated that user interface 700 can include a “Prompted” field. For example, if the filter is defined as “Region=Prompt User,” the end user will be prompted at run-time for the filter on Region.

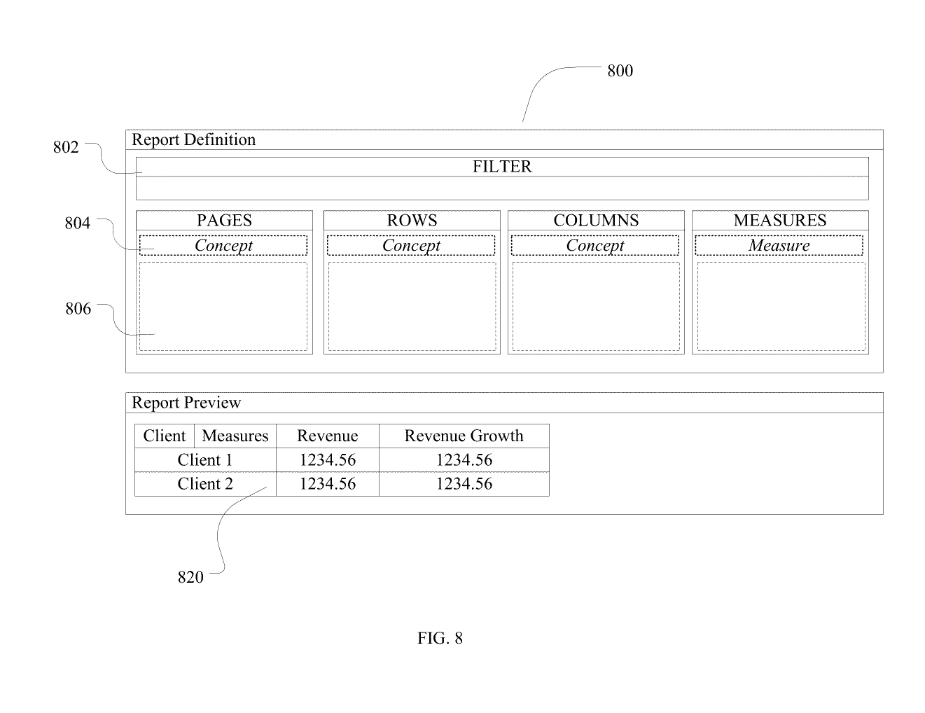

Report definitions, for example as shown in FIG. 8, are designed to capture requirements for traditional business intelligence grids and graphs. Organizations use reports to look at key measures across various dimensions or lines of business. FIG. 8 depicts a user interface 800 for the definition of report objects, including fields for user 14 to input: filter condition(s) 802, if applicable; pages (e.g., objects that display a single element at a time); rows (e.g., objects to display in the rows of a report); columns (e.g., objects to display in the columns of a report); measures (e.g., the measure objects to be included on the report). Each of the template objects can contain autocomplete fields 804 and dropzone fields 806, such as described elsewhere herein. Measures may be shown in rows or columns.

As report definitions are created or edited, the look and feel of the report can be previewed using dummy data, for example as shown in preview grid 820. The report preview gives user 14 a representation of the end product before development even begins, thus eliminating problems with erroneous expectations based on misunderstanding of the reporting tool capabilities.

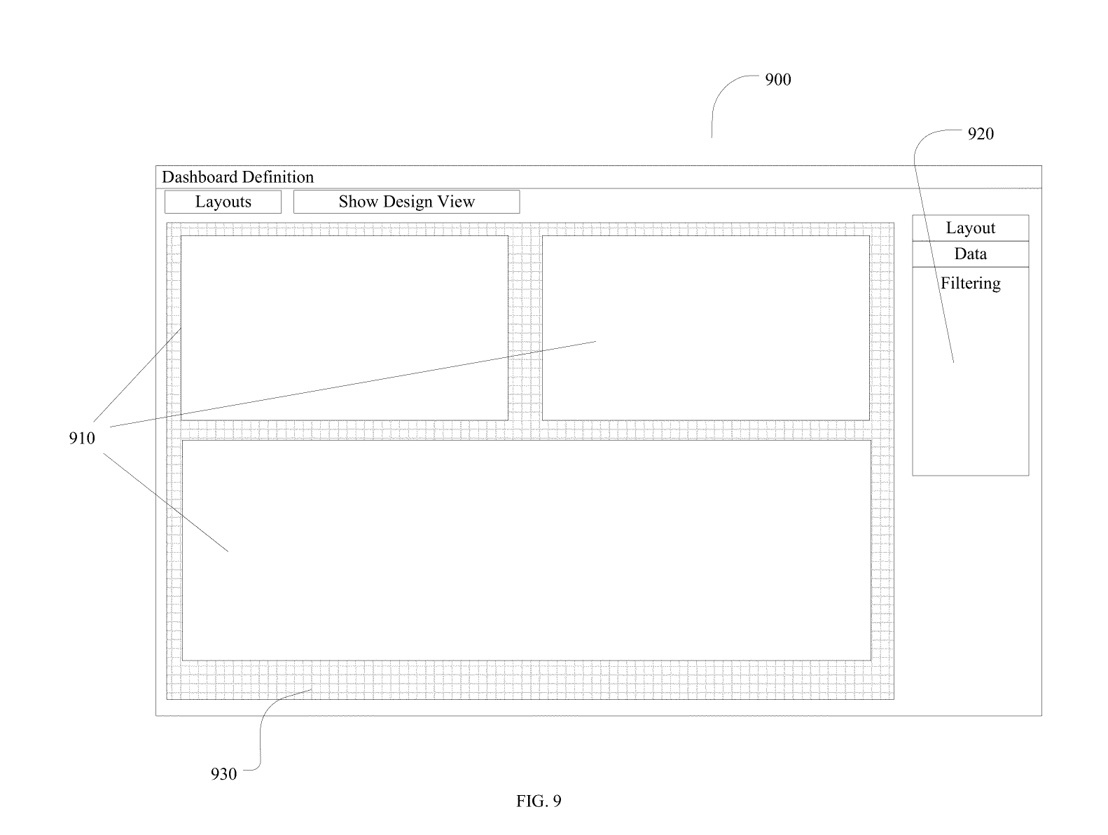

Dashboard definitions, for example as shown in FIG. 9, are designed to capture requirements for highly visual business intelligence analysis. Dashboards can be used by organizations to aggregate large quantities of data while highlighting positive and negative trends and data points. A dashboard can provide enormous insight into an organization, but getting value from large volumes of data often requires multiple dashboard design iterations. FIG. 9 depicts a user interface 900 for the definition of dashboard objects, thereby reducing wasted development cycles by helping organizations mockup and agree on dashboard design before costly projects begin.

Dashboard design consists of two primary elements—the visual “look and feel” of a dashboard and the technical requirements of which concepts, measures, reports, and filters are included in the dashboard. As shown in FIG. 9, a preview of the dashboard can be provided by displaying visual data components 910 such as grids, graphs, geographic maps, and the like, on a canvas 930. Each component can be resized, relocated, or removed from the canvas as necessary to achieve the desired look and feel of the dashboard.

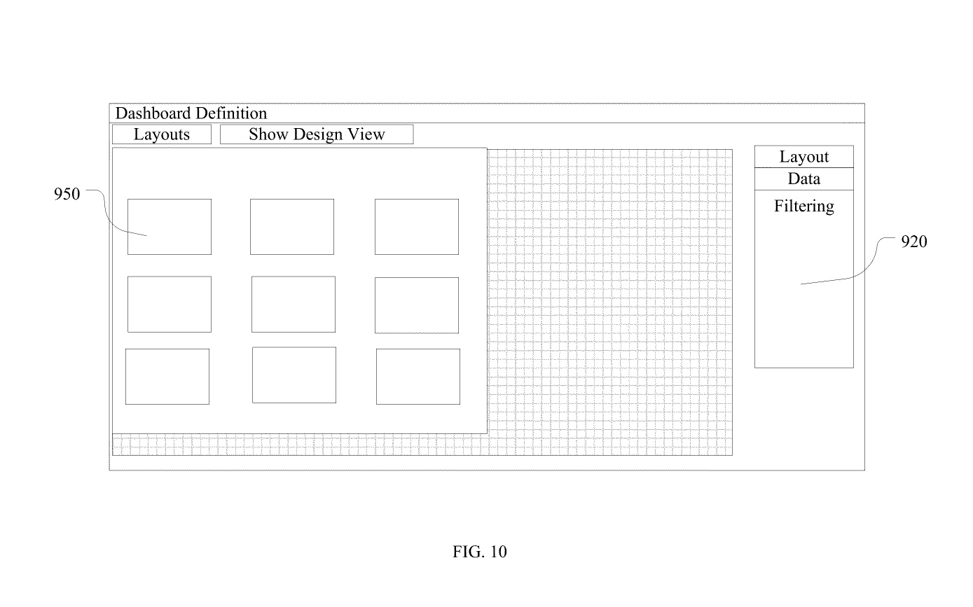

It is contemplated that components can be added to a dashboard by selecting pre-selected components 910 from a list of layout previews 950, as depicted in FIG. 10. Alternately or additionally, dashboard components can be dragged and dropped from component toolbar 920, which includes multiple component types. More particularly, the components available in the component toolbar can be divided into the following groups:

Layout Components—used to format the dashboard (e.g., images, text);

Data Components—used to display report data in various forms from grid to graph to data visualization; and

Filter Components—used to filter the data displayed in other filter or data components.

Additionally, a design view can be provided to allow users to specify the technical requirements for each dashboard component.

For data components, user 14 can further specify: existing report definitions; filter conditions; and concepts and measures as template objects (rows, columns, and measures).

For filter components, user 14 can specify: a concept object to be designated as the selector for the filter; and other dashboard components which will be filtered by the selection.

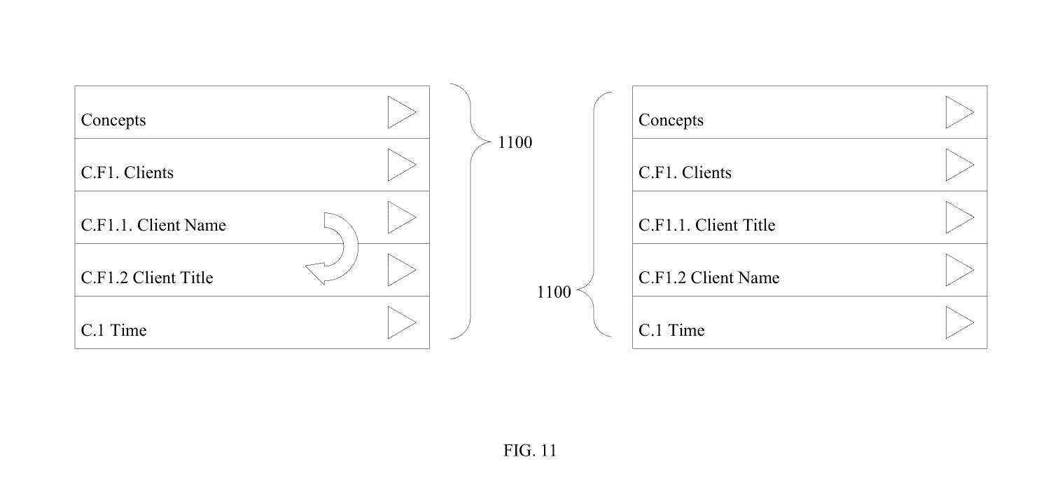

When an object is created, a requirement number can be assigned for documentation purposes. The requirement number can be based on an automatic numeric sequencing within the object's selected folder (e.g., sequential numbering for each object type). User 14 can, however, re-sort requirement numbers by dragging and dropping objects within a sortable list 1100, shown in FIG. 11, thus enabling user 14 to organize requirement objects in any manner necessary or desirable.

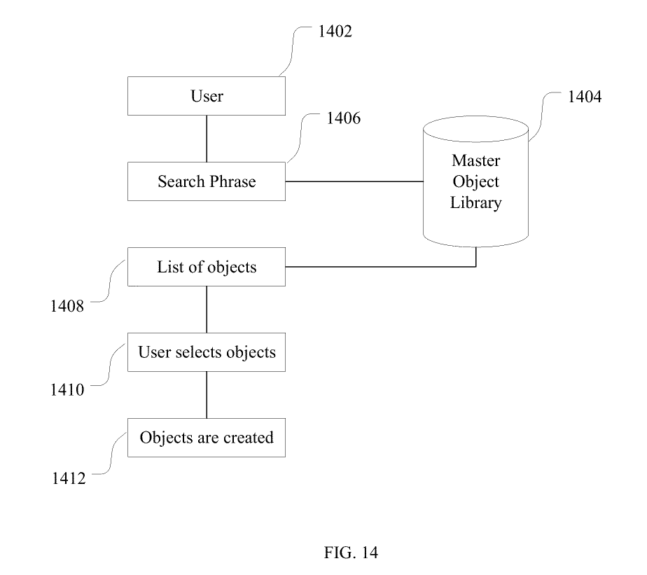

Object library 402 can be searched based on criteria including, without limitation, name, object type, status, assignee, and inclusion in other objects. Searching based on status or assignee can provide user 14 with insight into project management workflow. Searching based on inclusion in other objects can provide a mechanism for impact analysis whereby user 14 can understand potential downstream effects to changing the requirements of one or more objects. In FIG. 14, for example, the search phrase 1406 queries the master object library 1404, and the results are returned to the user with a list of objects 1408.

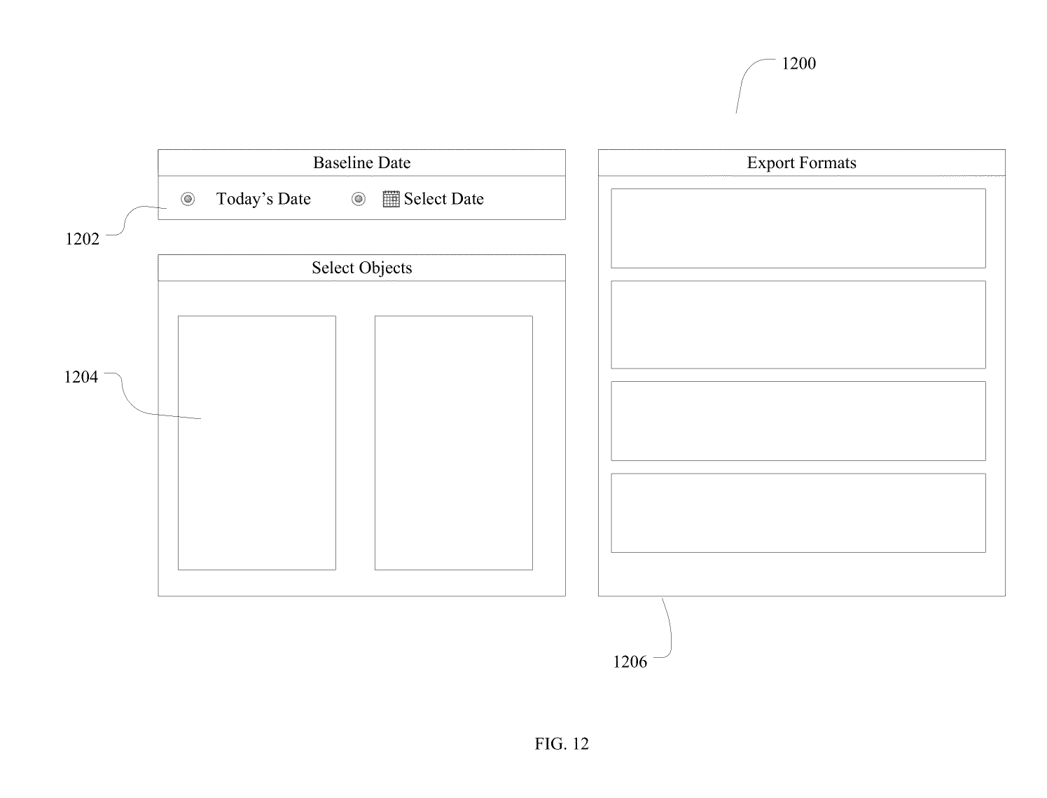

User 14 can also automatically generate requirements documentation for export. For example, as illustrated in FIG. 12, user 14 can use interface 1200 to select to export the requirements as of the moment of export and/or to view a baseline of the project by selecting a previous point in time in baseline date panel 1202. Indeed, because it is contemplated that all saved changes to objects in the object library will be time-stamped, user 14 can view “as is” or “as was” requirements for any date and time. In addition, user 14 can select which objects to document from a list of all available objects in available objects pane 1204.

The highly formatted documentation displays all data captured through the user interfaces described herein, and, where applicable, can display both technical requirements and report or dashboard previews. Documentation formats include, but are not limited to, Portable Document Format (PDF), Extensible Markup Language (XML), Microsoft Excel, and Microsoft Word, and can be shown in export format pane 1206.

Even after requirements have been captured and documented, organizations can struggle with change management. Advantageously, the methods and systems disclosed herein can maintain and display a list of all historical modifications for each object in object change history pane 410 (see FIG. 4). The changes displayed can include, but are not limited to, date/time of change, identification of the user that made the change, and details about the change. Furthermore, as discussed above, these changes can be associated with a requirements gathering session, which can further enhance a project manager's understanding of when and why project scope changes occur.

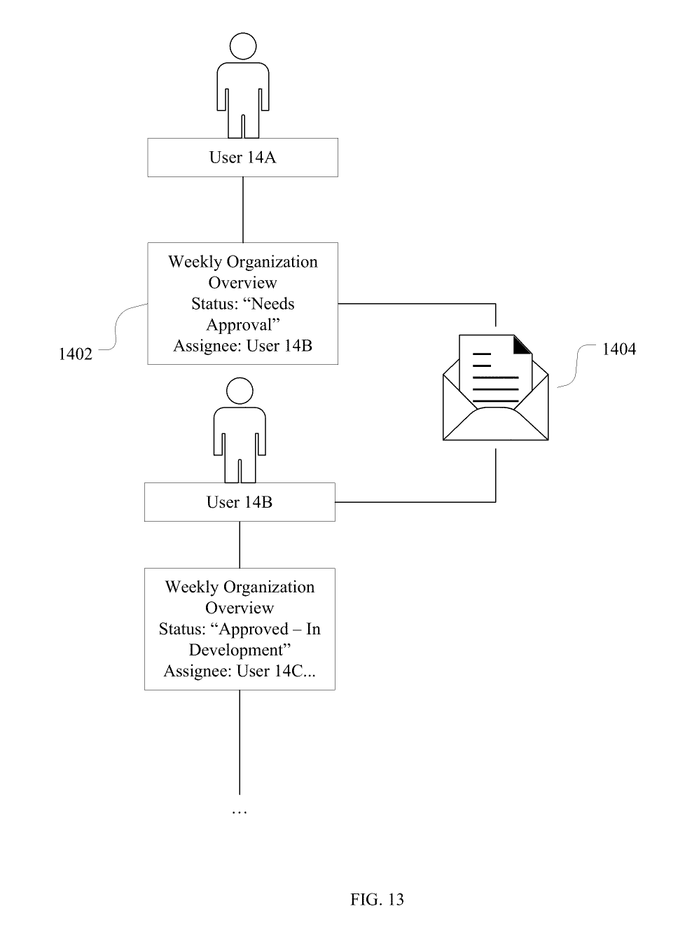

It is also desirable for a reporting implementation to deliver according to the requirements set out by the end users. To this end, and as illustrated in the flowchart of FIG. 13, user 14A can assign a status to an object and then assign the status to user 14B (block 1402). For example, when the requirements have been fully gathered for a dashboard named “Weekly Organization Overview,” user 14A, who documented the requirements can assign a status of “Needs Approval” to the dashboard and assign the task to the business sponsor, user 14B. User 14B can receive an email notification of the status assignment (block 1404), which can include a hyperlink to view the dashboard requirements. If satisfied, user 14B can set the status to “Approved—In Development” and assign the object to a developer (e.g., user 14C) in similar fashion to that described above. The various statuses and users in this workflow can be configured by a project administrator, thereby enabling organizations to build out this workflow in any desirable fashion.

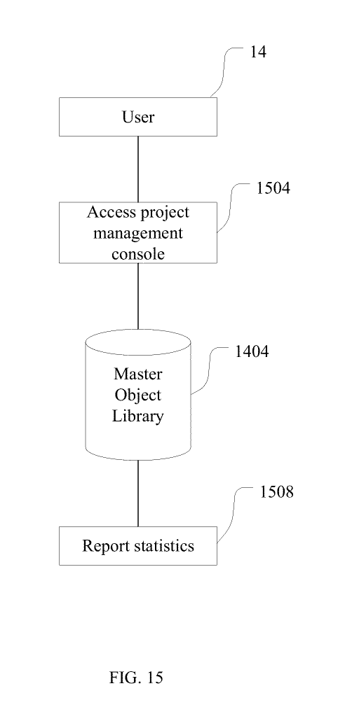

User 14 can also report on statistics, for example via a method including the representative steps shown in the flowchart of FIG. 15. For example, user 14 may wish to see how many objects are in each status, how many objects are assigned to a particular user, the average “dwell time” for each status in the workflow, and the like. User 14 can utilize a user configurable project management console 1504 to access master object library 1404 and return the desired statistics 1508.

In certain aspects, the teachings herein can be applied to automatically generate a MicroStrategy project and base report objects from the requirements. For example, after providing connection information and credentials for a MicroStrategy Intelligence Server, new report objects can be created and existing report objects can be updated by using the MicroStrategy open API and/or by using automatically generated MicroStrategy Command Manager™ scripts.

Thus, once concepts, measures, and reports are fully defined within object library 402, the appropriate MicroStrategy reporting objects can be created and/or modified. This project management feature keeps report requirements consistent with MicroStrategy project report objects, eliminates errors in creating report objects, and reduces project development time.

In the event a MicroStrategy project report object differs from the report requirement defined according to the teachings herein, a comparison between requirements can be presented to user 14, the differences can be highlighted, and user 14 can choose how to resolve the conflict (e.g., whether the report requirements should be updated to reflect the MicroStrategy report objects, or whether the MicroStrategy report objects should be updated to reflect the report requirements).

Although organizations typically have unique reporting requirements, there is still commonality in how different organizations report on their data. For example, many organizations divide data up by time segments—such as by time of day, date, week, month, quarter, etc., or some combination of time segments. To aid users in creating requirements more efficiently and thinking more broadly about the scope of requirements, FIG. 14 depicts a representative logic by which additional requirement objects can be suggested to user 14. For example, if user 14 creates a concept named “Month” in block 1402, server device 18 can search this concept against a master object library 1404 in block 1406. Because “Month” is commonly used in the time dimension, a list of suggested objects (e.g., Date, Week, Quarter, Year) can be output in block 1408. User 14 can select from the suggestion list in block 1410, and the selected concepts will automatically be added to the object library in block 1412.

The foregoing requirement suggestion feature can apply to all object types. For example, when a user creates a new measure named “Profit,” the suggestion list output in block 1408 can include other measures that comprise Profit, such as Cost and Revenue. The suggestion list can also include other related measures, such as Profit Last Year, Profit Year to Date, Profit % Growth vs. Last Year, and the like.

Moreover, when creating reports and dashboards, additional reports and dashboards can be suggested that will allow the data to be viewed at different levels of granularity and/or analyzed with different measures. For example, assume an organization reports data using the following concepts: Country, Region (where every Country contains one or more Regions), and State (where every Region contains one or more States). Additionally, the organization measures the success of the business using Profit measures (Cost, Revenue, Profit, and the like) and Customer Retention measures (# of Customers, % of Repeat Customers, and the like). When a user creates a report named “Profit by Region,” therefore, the suggestion list can include reports such as Profit by Country, Profit by State, and Customer Retention by Region.

Advantageously, by leveraging these requirement suggestions, users can be certain they have built a comprehensive set of requirements.

Although certain embodiments of this invention have been described above with a certain degree of particularity, those skilled in the art could make numerous alterations to the disclosed embodiments without departing from the spirit or scope of this invention.

For example, the methods described herein can be either hardware- or software-implemented.

All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A method of capturing business intelligence requirements, comprising:
(a) establishing a graphical object definition interface;
(b) receiving, through the graphical object definition interface, user input to define a requirements object;
(c) storing the requirements object defined by the user input in an object library;
(d) repeating steps (a), (b), and (c) to store a plurality of requirements objects in the object library;
(e) establishing a graphical business intelligence outputs interface; and
(f) receiving, through the graphical business intelligence outputs interface, user input to define a business intelligence output, wherein the business intelligence output comprises at least one requirements object from the object library expressed as at least one of a report and a dashboard.

2. A system for capturing business intelligence requirements, comprising:
an object definition interface processor that generates a graphical object definition interface and that receives, via the graphical object definition interface, user input to define a plurality of requirements objects; and
a business intelligence outputs interface processor that generates a graphical business intelligence outputs interface and that receives, via the graphical business intelligence outputs interface, user input to define a business intelligence output, wherein the business intelligence output comprises at least one requirements object from the plurality of requirements objects expressed as at least one of a report and a dashboard.

3. The method according to claim 1, wherein receiving, through the graphical object definition interface, user input to define a requirements object comprises receiving, through the graphical object definition interface, user input to define a concept object, user input to define a measure object, or user input to define a filter object.

4. The method according to claim 3, wherein the user input to define a concept object comprises a source data location input and a target data location input.

5. The method according to claim 3, wherein the user input to define a measure object comprises a source input and an aggregation input.

6. The method according to claim 3, wherein the user input to define a filter object comprises a conditional logic input.

7. The method according to claim 1, wherein the graphical object definition interface comprises a graphical object editor interface, the graphical object editor interface including an object general information pane, an object definition pane, an object change history pane, and an object workflow pane.

8. The method according to claim 1, wherein the graphical business intelligence outputs interface comprises a graphical report definition interface.

9. The method according to claim 1, wherein the graphical business intelligence outputs interface comprises a graphical dashboard definition interface.

10. The method according to claim 9, wherein the graphical dashboard definition interface comprises a graphical dashboard look and feel definition interface and a graphical dashboard content interface.

11. The system according to claim 2, wherein the graphical object definition interface comprises one of a graphical concept object definition interface, a graphical measure object definition interface, and a graphical filter object definition interface.

12. The system according to claim 11, wherein the graphical concept object definition interface comprises a source data location input field and a target data location input field.

13. The system according to claim 11, wherein the graphical measure object definition interface comprises a source input field and an aggregation input field.

14. The system according to claim 11, wherein the graphical filter object definition interface comprises a conditional logic input field.

15. The system according to claim 2, wherein the graphical business intelligence outputs interface comprises a graphical report definition interface.

16. The system according to claim 2, wherein the graphical business intelligence outputs interface comprises a graphical dashboard definition interface.

17. The system according to claim 16, wherein the graphical dashboard definition interface comprises a graphical dashboard look and feel interface and a graphical dashboard content interface.

18. A non-transitory computer readable medium storing a program causing a computer to execute a process comprising:
establishing a graphical object definition interface;
receiving, through the graphical object definition interface, user input to define a requirements object;
storing the requirements object defined by the user input in an object library;
establishing a graphical business intelligence outputs interface; and
receiving, through the graphical business intelligence outputs interface, user input to define a business intelligence output, wherein the business intelligence output comprises at least one requirements object from the object library expressed as at least one of a report and a dashboard.
